(19) United States
(12) Patent Application Publication
(10) Pub. No.: US 2026/0202062 A1
(43) Pub. Date: Jul. 16, 2026

(54) FIREPLACE WITH QUICKLY DETACHABLE PANEL

(71) Applicant: Source Pro Industries Ltd., Kowloon Bay (HK)

(72) Inventors: Jackey CHU, Kowloon Bay (HK); Charles LAM, Kowloon Bay (HK)

(73) Assignee: Source Pro Industries Ltd., Kowloon Bay (HK)

(21) Appl. No.: 19/020,051

(22) Filed: Jan. 14, 2025

(51) Int. Cl. F24B 1/195; F16B 5/00

(52) U.S. Cl. CPC F24B 1/195; F16B 5/0036

(57) ABSTRACT

The present disclosure relates to a fireplace with a quickly detachable panel, comprising a fireplace body, at least one side of which is provided with an opening, wherein the opening is provided with a front panel, one side of the opening is provided with an accommodating portion, one end of the front panel is placed in the accommodating portion, the fireplace body is also provided with a positioning assembly for positioning the front panel.

### TECHNICAL FIELD

The present disclosure generally relates to a fireplace, in particular to a fireplace with a quickly detachable panel.

### BACKGROUND

A fireplace is a type of heater used for heating air, usually consisting of a panel including at least one of a front panel and a side panel provided inside the fireplace body, a heating assembly, and a simulation assembly, the front panel is usually made of transparent or translucent material. The simulation assembly in the fireplace body is usually a flame assembly, but it can also be other types, such as those that show animals or stars or oceans. A heating assembly can typically be placed above or below the front panel.

In the prior art, the connection type between the panel especially the front panel and the fireplace body comprises a fastener connection, a plug-in connection and a hinged connection. In the case of a fastener connection, there is usually a mounting hole in the front panel, the fastener is passed through the mounting hole on the front panel, and then the front panel is fixed to the fireplace body or fixed to a mounting member provided on the fireplace body through a fastener. This connection type requires to provide punching holes on the front panel and fireplace body, which will not only reduce the structural strength thereof, but also make the mounting and detaching operation very complicated. In the case of a plug-in connection, the mounting pieces with slots are usually installed on the fireplace body, and the front panel is inserted into the slots for positioning and installation. Although this connection type is easy for installing, when detaching the front panel, all the top or bottom parts of the front panel need to be removed to take out the front panel, which would be a very complicated operation for that. In the type of hinged connection, it is usually necessary to set the front panel into double portions, and then the two sides of the front panel are respectively hinged to the fireplace body. This connection type is also complicated for installing and detaching, and the front panel is unsightly.

Therefore, a fireplace that is easy to assemble and disassemble and take less structural damage to the panel and fireplace body is required.

### SUMMARY

The purpose of the present application is to design a fireplace with a quickly detachable panel, which can not only be easily detached and assembled, but also does not need to punch holes in the panel or fireplace body, so that it is very convenient to detach and assemble and would take less damage to the structure.

A fireplace with a quickly detachable panel according to the present application, comprising a fireplace body, at least one side of which is provided with an opening, wherein a panel is provided in the opening, one side of the opening is provided with an accommodating portion, one end of the panel is placed in the accommodating portion, the fireplace body is provided with a positioning assembly for positioning the panel, by manually operating which the panel can be assembled and detached. The panel mentioned above could be a front panel or a side panel or both.

In some embodiments, the accommodating portion could be integrally formed with the fireplace body, or the accommodating portion could be separately arranged, which is fixed to the fireplace body.

Preferably, the positioning assembly could comprise a rebounding member and a pressing member, the panel could be arranged between the pressing member and the rebounding member; the pressing member could comprise a pressing base and a pressing portion, an elastic part could be arranged between the pressing base and the pressing portion, the pressing portion can move relative to the pressing base through the elastic part; inside of the pressing base could be provided with a cavity, in which a guide post could be arranged, the guide post could be arranged at the pressing base, and inside of the pressing portion could be provided with a guide hole in which the guide post can be moved back and forth; inside the guide hole could be arranged with a spring, a part of which extends into the guide hole and the other part of which could be arranged around the guide post.

In some embodiments, the outward side of the pressing portion could be an inclined side, along which the panel could be pushed inward, and the inward side of the pressing portion could be a vertical side by which the panel is blocked after being positioned; the pressing base could be provided with a lug for limiting the position of the pressing member; the rebounding member could comprise a fixing part, a housing part and a telescopic part, the rebounding member could be fixed at an installation position through the fixing part, and the housing part could be arranged on the fixing part; inside the housing part could be provided with a cavity, along which the telescopic part can be retracted and popped out, or the telescopic part could be an elastic member.

In some embodiments, further comprising a heating assembly, the fireplace body could be provided with a slide rail, and the heating assembly can be installed on the slide rail in a sliding manner; wherein the heating assembly comprises a heater and an extension portion arranged on at least one side of the heater.

The present application also relates to a method for assembling a panel of a fireplace, comprising:
providing a fireplace in a detached state, wherein the fireplace is provided with a plurality of independent components;
assembling the plurality of independent components to form a fireplace body of the fireplace, wherein at least one side of the fireplace body is provided with an opening at which a panel is provided; and one side of the opening is provided with an accommodating portion, the other side of the opening is provided with a positioning assembly for positioning the panel, the positioning assembly comprises a rebounding member and a pressing member, between which a gap for accommodating the panel is arranged;
placing one end of the panel in the accommodating portion; and
pushing the other end of the panel to squeeze the pressing member, so that the panel is snapped into the gap between the pressing member and the rebounding member.

The present application also relates to a method for detaching a panel of a fireplace, which has a fireplace body, comprising:
providing a fireplace in an assembled state, wherein at least one side of the fireplace body is provided with an opening, at which at least a panel is provided, one side of the opening is provided with an accommodating portion, in which one end of the panel is placed in; the other side of the opening is provided with a positioning assembly for positioning the panel, the positioning assembly comprises a rebounding member and a pressing member, between which the panel is arranged;
pressing the pressing portion of the pressing member to release a space for the panel, and squeezing the panel to pop out by the force of the rebounding member; or, mutually exchange the steps of pressing the pressing portion and squeezing the panel;
taking out the end of the panel placed in the accommodating portion.

In some embodiments, wherein the pressing member could comprise a pressing base and a pressing portion, and an elastic part could be arranged between the pressing base and the pressing portion;
the rebounding member could comprise a fixing part, a housing part and a telescopic part, the rebounding member could be fixed at an installation position through the fixing part, and the housing part could be arranged on the fixing part;
the outward side of the pressing portion could be an inclined side, and the inward side of the pressing portion could be a vertical side;
pressing the pressing portion to release the panel from being blocked by the vertical side of the pressing portion, thereby leaving a space for the panel to be popped out; then squeezing the panel inward, to further squeeze the telescopic part of the rebounding member to flip forward the panel; or, mutually exchange the steps of pressing the pressing portion and squeezing the panel.

According to the present application, by the pressing member and the rebounding member that cooperate with each other, the assembling and detaching operation of the panel can be very convenient and quick. Besides, there is no need to provide a mounting hole on the panel and the fireplace body, therefore the structural damage to the panel and the fireplace body could be avoided.

### BRIEF DESCRIPTION OF THE DRAWINGS

These and other features, aspects, and advantages of the present invention will become better understood with reference to the following description, appended claims, and accompanying drawings, in which similar reference characters refer to similar parts, and in which:

FIG. 1 is an exploded view of a first embodiment of the fireplace of the present application.

FIG. 2 is another embodiment of the ornamental part of the fireplace of the present application.

FIG. 3 is a schematic diagram of the pressing member and the rebounding member, when the front panel is in a mounted state.

FIG. 4 is a schematic diagram of the pressing member and rebounding member, when the front panel is in a detached state.

FIG. 5 is a schematic diagram of the pressing member of the present application.

FIG. 6 is a cross-sectional view of the pressing member of the present application.

FIG. 7 is a schematic diagram of the rebounding member of the present application.

FIG. 8 is a perspective view of the fireplace shown in FIG. 1.

FIG. 9 is a perspective view of a second embodiment of the fireplace in the present application.

FIG. 10 is an exploded view of the second embodiment of the fireplace shown in FIG. 9.

### DETAILED DESCRIPTION

In order to make the objectives, technical solutions and advantages of the present disclosure clearer, the embodiments of the present disclosure will be described below in detail with reference to the accompanying drawings. The different embodiments, in particular the technical features in different embodiments, of the present disclosure may be combined with each other if not conflicted.

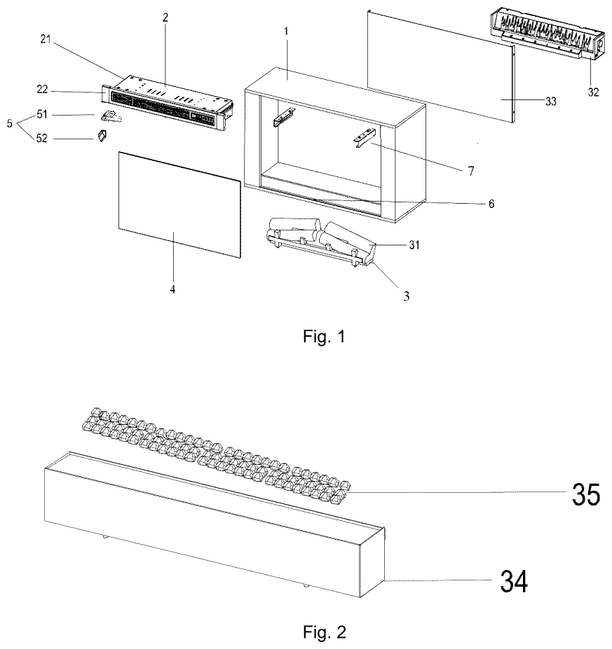

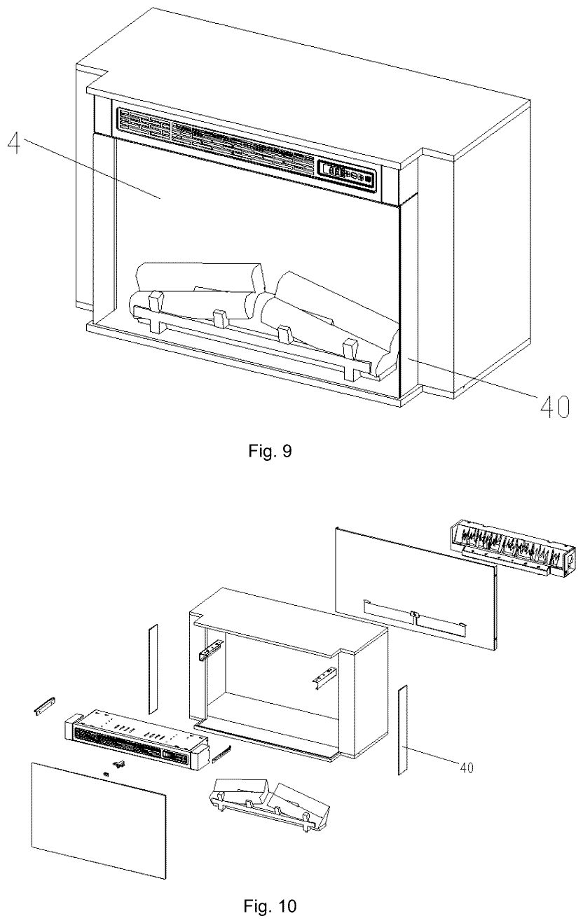

As shown in FIG. 1-8, in a first embodiment of the present application, it is provided a fireplace with a quickly detachable front panel, comprising a fireplace body 1, a heating assembly 2 and a simulation assembly 3 which are arranged in the fireplace body 1. The front side of the fireplace body 1 is provided with an opening, and the opening is provided with a front panel 4. The front panel 4 may be a transparent front panel or a translucent front panel. One side of the opening is provided with an accommodating portion 6, and one end of the front panel 4 is placed in the accommodating portion 6. The accommodating portion 6 may be integrally molded on the fireplace body 1, or the accommodating portion 6 may be a separately arranged part which is mounted on the fireplace body 1. In the embodiment shown in the accompanying drawings, the accommodating portion 6 could be arranged at the bottom of the front end of the opening, and the lower end of the front panel 4 is placed in the accommodating portion 6. Accordingly, the front panel can be assembled and detached from an above direction. Those skilled in the art can understand that the accommodating portion may also be arranged on other sides of the opening, so that the front panel can also be opened from other directions. In the embodiments shown in the FIG. 1, only the front side of the fireplace body is provided with an opening. However, the person skilled in the art could understand that a side panel could also be provided in the opening, such as the embodiment shown in FIGS. 9-10, which is also included in the protection scope of this application. The panel mentioned above could be at least one of a front panel and a side panel.

The fireplace is also provided with a positioning assembly 5 for positioning the front panel 4 in the fireplace, which can be manually operated to detach and assemble the front panel. Specifically, the positioning assembly 5 comprises a rebounding member 51 and a pressing member 52. Preferably, the rebounding member and the pressing member are set in a same position, for example, they can be both set in the upper part of the front panel to facilitate manual operation by the user. When the front panel is positioned, the pressing member 52 is arranged on the outside of the front panel 4, and the rebounding member 51 is arranged on the inside of the front panel 4.

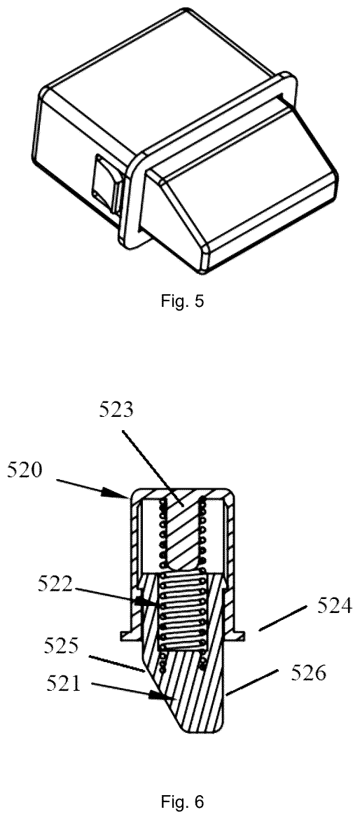

As shown in FIGS. 5-6, the pressing member 52 comprises a pressing base 520 and a pressing portion 521, an elastic part 522 is arranged between the pressing base 520 and the pressing portion 521. The pressing portion 521 can be moved relative to the pressing base 520 through the elastic part 522. Specifically, a cavity is arranged inside the pressing base 520, and a guide post 523 is arranged in the cavity of the pressing base 520. The guide post 523 may be arranged at the bottom of the pressing base 520. Preferably, the guide post 523 can be integrally formed with the pressing base 520, or the guide post 523 can be formed separately and fixed to the pressing base 520. The inside of the pressing portion 521 is provided with a guide hole that can be used for the guide post 523 to enter and exit, and an elastic part 522 such as a spring could be arranged inside the guide hole of the pressing portion 521. A part of the spring 522 extends into the inside of the guide hole, and the other part of the spring 522 is arranged around the guide post 523. Preferably, the outward side of the pressing portion 521 is an inclined side 525, so that the front panel could be conveniently pushed inward along the inclined side 525. The inward side of the pressing portion 521 is a vertical side 526, so that the front panel could be blocked when it is positioned to prevent from falling down. Preferably, the pressing base 520 is also provided with a lug 524, and the pressing member 52 can be positioned in a mounting position by the lug 524.

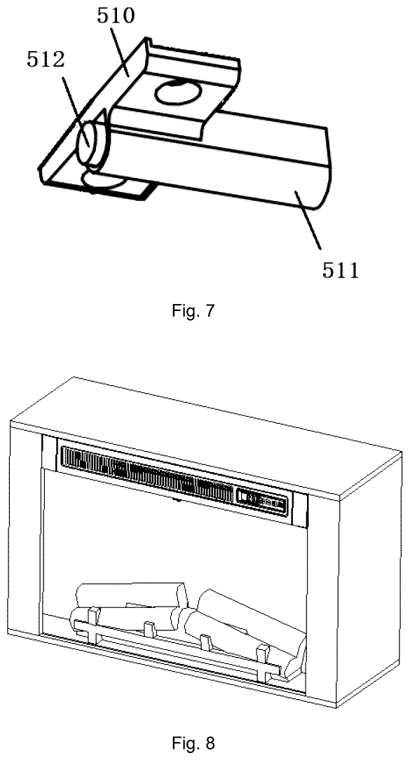

As shown in FIG. 7, the rebounding member 51 comprises a fixing part 510, a housing part 511 and a telescopic part 512. The rebounding member 51 is fixed in the mounting position through the fixing part 510, and the housing part 511 is arranged on the fixing part 510. The housing part 511 is provided with a cavity, and the telescopic part 512 can be retracted and popped out along the cavity of the housing part 511. Preferably, the telescopic part 512 can be in form of a post, the housing part 511 is provided with a telescopic hole through which the telescopic part 512 can be retracted and popped out. In an alternative embodiment, the telescopic part 512 may even be made of an elastic material so that it could be inherently elastic.

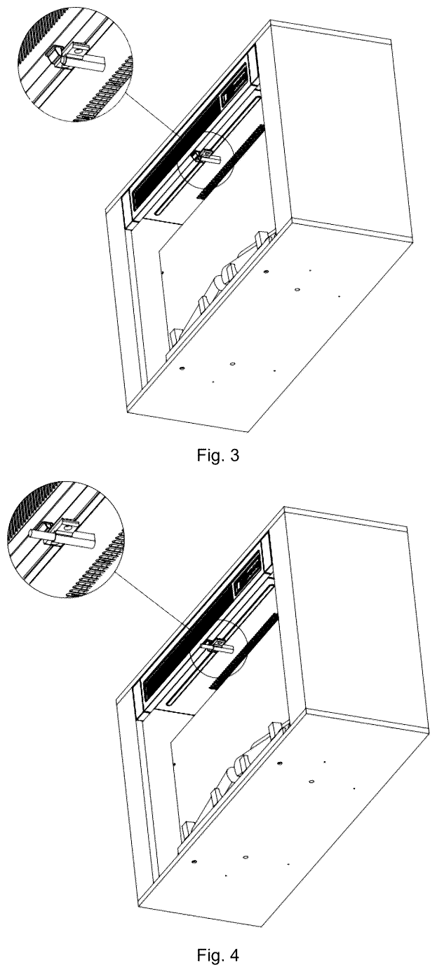

As shown in FIGS. 3-4, the positioning assembly 5 is arranged at the top of the front panel 4, and the bottom of the front panel 4 is arranged in the accommodating portion 6. Wherein, the telescopic part 512 of the rebounding member 51 moves in a horizontal direction, and the pressing portion 521 of the pressing member 52 moves in a vertical direction. When the front panel is installed, the front panel 4 is placed between the telescopic part 512 of the rebounding member 51 and the pressing portion 521 of the pressing member 52, with the vertical side of the pressing portion 521 abutting against the outer surface of the front panel 4 to prevent the front panel 4 from flipping forward.

When the front panel needs to be detached, the user presses the pressing portion 521 to retract it, and the vertical side of the pressing portion 521 would release the front panel, thereby leaving a space for the front panel to be flipped over. Then, the front panel 4 is squeezed inward, and the telescopic part 512 is squeezed. The front panel 4 is subjected to a forward push force of the telescopic part 512, and the top of the front panel 4 can be flipped forward, so that the front panel 4 could be popped out. Or, the steps of pressing the pressing portion and squeezing the front panel could be mutually exchanged. That would also work.

When the front panel needs to be installed, the bottom of the front panel 4 is placed into the accommodating portion 6, and then the top of the front panel 4 is pushed inwardly. When the front panel 4 touches the pressing portion 521, the front panel starts to push the pressing portion 521 upwards along the inclined side 525. Accordingly, the pressing portion 521 starts to be retracted into the cavity of the pressing base 520. As the front panel continues to advance, the front panel passes over the vertical side 526 of the pressing portion 521, then the pressing portion 521 will be popped out under the effect of the spring 522, so that the vertical side 526 of the pressing portion 521 can block the front panel. Simultaneously, the other side of the front panel is blocked by the telescopic part 512 of the rebounding member 51, achieving the positioning of the front panel. With such a rebounding member and a pressing member, this application can make the mounting of the front panel to be easily, and there is no need to punch holes in the front panel for installation.

In the present application, the heating assembly 2 may be located above or below the simulation assembly 3. As shown in FIG. 1, the heating assembly 2 is located above the simulation assembly 3. Two slide rails 7 are arranged on the fireplace body 1, and the heating assembly 2 can be slidably installed onto the two slide rails 7, so that the disassembly and assembly of the heating assembly are more convenient. In this embodiment, the rebounding member 51 and the pressing member 52 can be both fixed at the lower surface of the heating assembly 2. When the heating assembly 2 is located below the simulation assembly 3, the rebounding member 51 and the pressing member 52 can be both fixed on the fireplace body.

As shown in FIG. 1, the heating assembly 2 comprises a heater 21 and two extension portions 22 arranged on the left and right sides of the heater 21. Both sides of the heater 21 are provided with the sliding grooves that interact with the slide rails 7. The hot air generated by the heater 21 is discharged outward through the front side of the heater 21. Specifically, the extension portions 22 can be in different shapes and sizes as required.

In this embodiment, the simulation assembly 3 may comprise an ornamental part such as a log module 31, a flame generator 32 and a display screen 33. The display screen 33 divides the fireplace body 1 into a front chamber and a rear chamber. The log module 31 is located in the front chamber, and the flame generator 32 is located in the rear chamber. When operating, the flame generator 32 in the rear chamber emits light, and the light is projected or reflected onto the display screen 33, so that a flame-like dynamic effect can be presented, and observed from the front panel side. As shown in FIG. 2, in other embodiments, the log module 31 can also be replaced with a crystal module 34 that is provided with a crystal 35.

As shown in FIGS. 9-10, in a second embodiment of the present application, it is provided a fireplace with a quickly detachable front panel and two side panels, comprising a fireplace body 1, a heating assembly 2 and a simulation assembly 3 which are arranged in the fireplace body 1. The front side of the fireplace body 1 is provided with an opening, and the opening is provided with a front panel 4 and two side panels 40, all of which are quickly detachable. The differences between the first and second embodiments lie in that the positioning assembly could be provided not only for positioning the front panel, but also for positioning at least one of the side panels, even could be provided only for positioning the side panels 40. So that, all of the front panel 4 and the two side panels 40 could be quickly detachable.

In a special embodiment shown in FIGS. 9-10, the positioning assembly is provided above the front panel 4 for positioning the front panel. Person skilled in the art could also understand that the positioning assembly could also be provided above the side panels 40 for positioning the side panels, in which the side panels could be quickly detachable by the positioning assembly as described above and the front panel could be provided in a push-in style from the side. When installing, the front panel is firstly mounted from the side in a push-in style, and then the side panels are mounted by the positioning assembly as described above. When detaching, at least one of the side panels are firstly detached by the positioning assembly as described above, and then the front panel is detached in a pull-out style.

Although the embodiments of the present disclosure are described above, the contents described are only embodiments to easily understand the present disclosure and not intended to limit the present disclosure. Without departing from the spirit and scope disclosed by the present disclosure, any person skilled in the art to which the application belongs can make any modifications and alterations to the forms and details of implementation. However, the protection scope of the present disclosure shall still be subject to the scope defined by the appended claims.

What is claimed is:

1. A fireplace with a quickly detachable panel, comprising a fireplace body, at least one side of which is provided with an opening, wherein a panel is provided in the opening, one side of the opening is provided with an accommodating portion, one end of the panel is placed in the accommodating portion, the fireplace body is provided with a positioning assembly for positioning the panel, by manually operating which the panel can be assembled and detached.

2. The fireplace according to claim 1, wherein the accommodating portion is integrally formed with the fireplace body, or the accommodating portion is separately arranged, which is fixed to the fireplace body.

3. The fireplace according to claim 1, wherein the positioning assembly comprises a rebounding member and a pressing member, the panel is arranged between the pressing member and the rebounding member.

4. The fireplace according to claim 3, wherein the pressing member comprises a pressing base and a pressing portion, an elastic part is arranged between the pressing base and the pressing portion, the pressing portion can move relative to the pressing base through the elastic part.

5. The fireplace according to claim 4, wherein inside of the pressing base is provided with a cavity, in which a guide post is arranged, the guide post is arranged at the pressing base, and inside of the pressing portion is provided with a guide hole in which the guide post can be moved back and forth.

6. The fireplace according to claim 5, wherein inside the guide hole is arranged with a spring, a part of which extends into the guide hole and the other part of which is arranged around the guide post.

7. The fireplace according to claim 4, wherein the outward side of the pressing portion is an inclined side, along which the panel is pushed inward, and the inward side of the pressing portion is a vertical side by which the panel is blocked after being positioned.

8. The fireplace according to claim 4, wherein the pressing base is provided with a lug for limiting the position of the pressing member.

9. The fireplace according to claim 3, wherein the rebounding member comprises a fixing part, a housing part and a telescopic part, the rebounding member is fixed at an installation position through the fixing part, and the housing part is arranged on the fixing part.

10. The fireplace according to claim 9, wherein inside the housing part is provided with a cavity, along which the telescopic part can be retracted and popped out, or the telescopic part is an elastic member.

11. The fireplace according to claim 1, further comprising a heating assembly, the fireplace body is provided with a slide rail, and the heating assembly can be installed on the slide rail in a sliding manner.

12. The fireplace according to claim 11, wherein the heating assembly comprises a heater and an extension portion arranged on at least one side of the heater.

13. A method for assembling a panel of a fireplace, comprising:
providing a fireplace in a detached state, wherein the fireplace is provided with a plurality of independent components;
assembling the plurality of independent components to form a fireplace body of the fireplace, wherein at least one side of the fireplace body is provided with an opening at which a panel is provided; and one side of the opening is provided with an accommodating portion, the other side of the opening is provided with a positioning assembly for positioning the panel, the positioning assembly comprises a rebounding member and a pressing member, between which a gap for accommodating the panel is arranged;
placing one end of the panel in the accommodating portion; and
pushing the other end of the panel to squeeze the pressing member, so that the panel is snapped into the gap between the pressing member and the rebounding member.

14. A method for detaching a panel of a fireplace, which has a fireplace body, comprising:
providing a fireplace in an assembled state, wherein at least one side of the fireplace body is provided with an opening, at which a panel is provided, one side of the opening is provided with an accommodating portion, in which one end of the panel is placed in; the other side of the opening is provided with a positioning assembly for positioning the panel, the positioning assembly comprises a rebounding member and a pressing member, between which the panel is arranged;
pressing a pressing portion of the pressing member to release a space for the panel, and squeezing the panel to pop out by the force of the rebounding member; or, mutually exchange the steps of pressing the pressing portion and squeezing the panel;
taking out the end of the panel placed in the accommodating portion.

15. The method according to claim 14, wherein the pressing member comprises a pressing base and a pressing portion, and an elastic part is arranged between the pressing base and the pressing portion;
the rebounding member comprises a fixing part, a housing part and a telescopic part, the rebounding member is fixed at an installation position through the fixing part, and the housing part is arranged on the fixing part;
the outward side of the pressing portion is an inclined side, and the inward side of the pressing portion is a vertical side;
pressing the pressing portion to release the panel from being blocked by the vertical side of the pressing portion, thereby leaving a space for the panel to be popped out; then squeezing the panel inward, to further squeeze the telescopic part of the rebounding member to flip forward the panel; or, mutually exchange the steps of pressing the pressing portion and squeezing the panel.
